(19) United States
(12) Patent Application Publication
(10) Pub. No.: US 2001/0023387 A1
(43) Pub. Date: Sep. 20, 2001

(54) Personal tour guide system

(76) Inventor: David Rollo, Bonsall, CA (US)

Correspondence Address: KIT M. STETINA, STETINA BRUNDA GARRED & BRUCKER, SUITE 250, 75 ENTERPRISE, ALISO VIEJO, CA, 92656, US

(21) Appl. No.: 09/832,494

(22) Filed: Apr. 11, 2001

Related U.S. Application Data
(63) Continuation of application No. 09/364,398, filed on Jul. 30, 1999.

(51) Int. Cl. G01C 21/26

(52) U.S. Cl. 701/200

(57) ABSTRACT

A personal tour guide system for providing a user selected information about a selected region. The system comprises a sighting device that is used to view the selected object. The sighting device provides bearing and tilt information that is used by a CPU to determine the location of the object being viewed relative to the user. The CPU uses this information and also the known position of the user in order to determine the specific location of the selected object being viewed. The system further comprises a storage device in communication with the CPU. The CPU determines the location of the selected object and retrieves such information about the selected object from the storage device and presents this information to the user.

### BACKGROUND OF THE INVENTION

The present invention generally relates to location finding systems and more particularly to a system that provides a user information about the particular location that is being viewed.

Often times, a passenger in an aircraft wishes to know what objects they are seeing through the windows of the aircraft. In order to receive such information, usually the pilot of the aircraft must make an announcement over the aircraft's public address system to the passengers. This can be annoying for many passengers who may be working or trying to sleep. Additionally, the pilot typically does not have the time to point out every landmark along the aircraft's route since he or she is busy piloting the aircraft.

Alternatively, in order to find information about objects being viewed, the passenger may look up such information in a book. If the passenger can determine the aircraft's present location, the passenger can then locate information about the selected point of interest in the book. However, often times it is difficult for the passenger to determine the aircraft's location and know exactly what is being viewed from the aircraft's window.

A similar problem exists for tourists visiting buildings and landmarks on the ground. For example, a tourist standing on the observation deck of the Empire State Building in New York might want to know information about other buildings surrounding the Empire State Building. The tourist must read signs placed on the observation deck of the building in order to obtain such information. However, the information on the signs is limited and often times is not updated.

The present invention addresses the above-mentioned deficiencies by providing a system that can easily convey information about points of interest to passengers in an aircraft or tourists at an observation point. In this respect, the present invention is able to determine the point of interest the passenger or tourist is viewing and present information about such point of interest directly.

### BRIEF SUMMARY OF THE INVENTION

In accordance with the preferred embodiment of the present invention, there is provided a personal tour guide system for presenting information about a selected point of interest within a prescribed region. The system comprises a sighting device for determining a selected point of interest within the prescribed region. In this respect, the sighting device includes a bearing indicator (i.e., compass) and/or a tilt indicator (i.e., inclinometer) which are operative to determine the selected point of interest relative to the position of the user.

The personal tour guide system further includes a storage device that contains data corresponding to the prescribed region. The storage device is in electrical communication with a central processing unit (CPU) and the sighting device such that the data regarding the selected point of interest within the prescribed region is accessible by directing the sighting device at the selected point of interest. The data may be stored in either audio format and/or video format.

The CPU is configured to determine the location of the selected point of interest and access the data corresponding to such point of interest. If the personal tour guide system is installed on an aircraft, then the system can access altitude and location information from either the aircraft's global positioning system or a self contained GPS system. In this respect, the processor will be configured to determine the location of the point of interest, relative to the position of the user, from the bearing and tilt information from the sighting device. As the position of the user is known from the altitude, longitude and latitude given from such, then the location of the point of interest can be calculated or otherwise determined.

The personal tour guide system of the preferred embodiment further includes an output device in communication with the storage device. The output device is operative to output the data regarding the selected point of interest. The output device may be either a speaker and/or video screen for presenting the data.

In accordance with the preferred embodiment of the present invention, there is provided a method of supplying information about a selected point of interest within a prescribed region with the personal tour guide system. The method comprises viewing the selected point of interest with the sighting device and then determining the location of such. Next, data about the selected point of interest is retrieved with the storage device. Finally, the data is presented by the output device.

### BRIEF DESCRIPTION OF THE DRAWINGS

These, as well as other features of the present invention, will become more apparent upon reference to the drawings wherein:

FIG. 1 is a perspective view of a user in an aircraft operating a personal tour guide system constructed in accordance with the preferred embodiment of the present invention;

FIG. 2 is a block level system diagram of the personal tour guide system constructed in accordance with the present invention;

FIG. 3 is perspective view of a sighting device for the personal tour guide system;

FIG. 4 is a perspective view of a user operating the personal tour guide system from a fixed location such as a building; and

FIG. 5 is a perspective view of the manner in which the personal tour guide system determines the location of a point of interest being viewed from an aircraft.

### DETAILED DESCRIPTION OF THE INVENTION

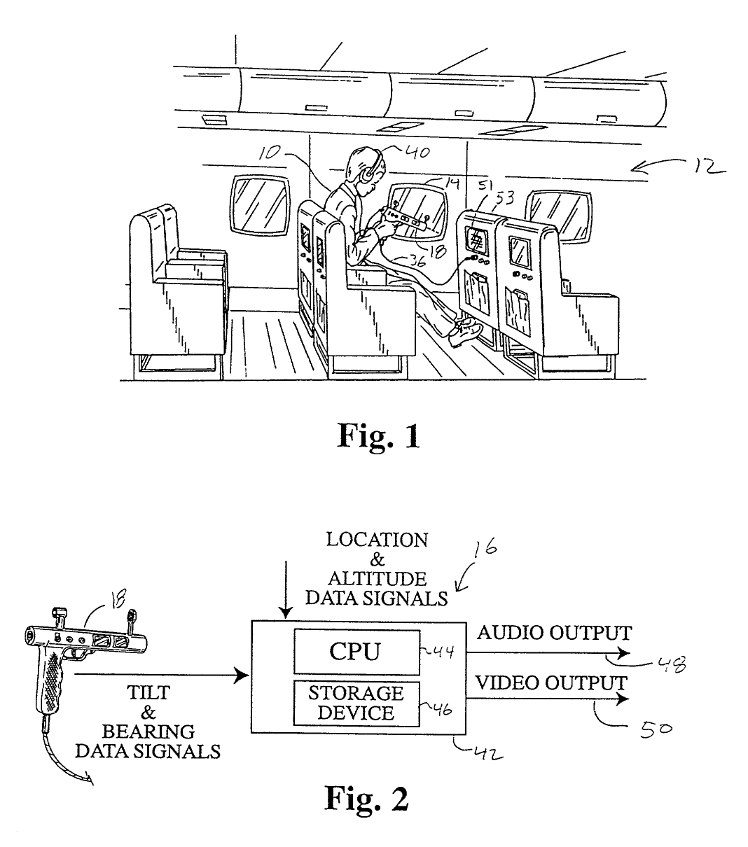

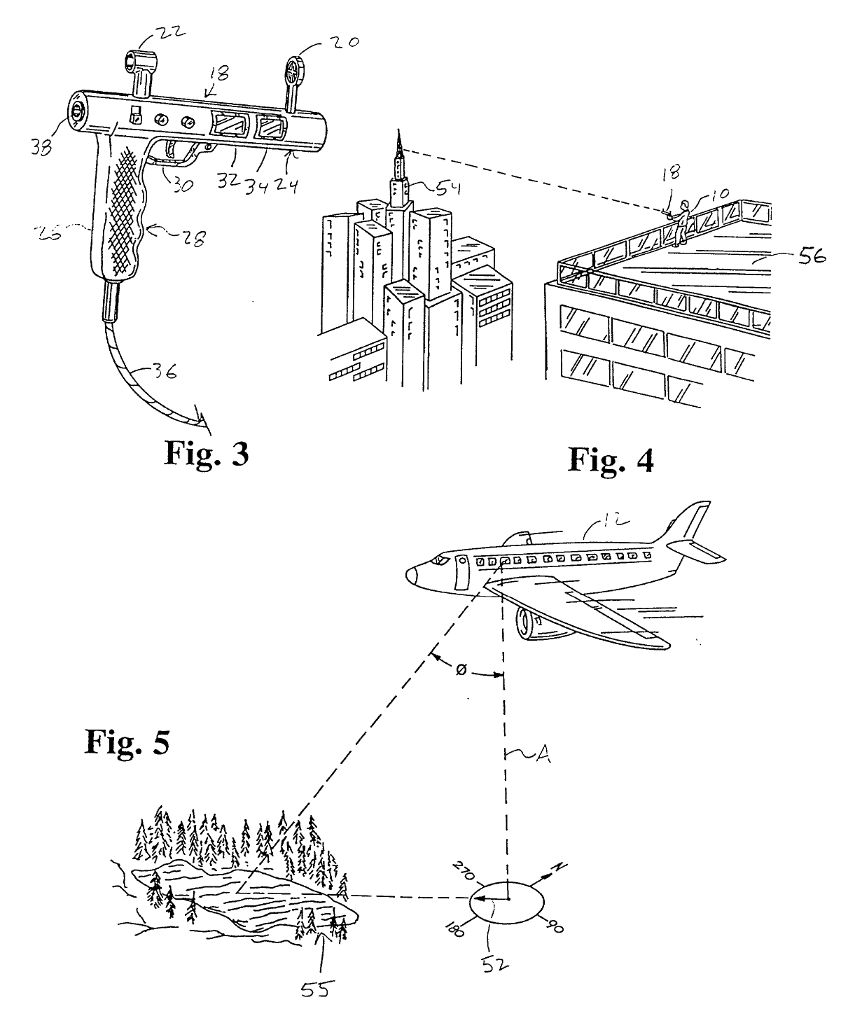

Referring now to the drawings wherein the showings are for purposes of illustrating a preferred embodiment of the present invention only, and not for purposes of limiting the same, FIG. 1 perspectively illustrates a user 10, such as a passenger in an aircraft 12, operating a personal tour guide system 16. The personal tour guide system 16 includes a sighting device 18 that is used to sight objects through an aircraft window 14.

Referring to FIG. 3, the sighting device 18 includes a forward sight 20 and a rear sight 22 disposed along a generally cylindrical barrel portion 24. The sights 20, 22 are used to line up an object that is being viewed. The sights 20, 22 are disposed in coaxial alignment along an axis which extends in generally parallel relation to a longitudinal axis of the barrel portion 24. Projecting generally perpendicularly to the barrel portion 24 is a handle portion 26 used to grip the sighting device 18. As seen in FIG. 3, the handle portion 26 includes a set of finger grips 28 disposed on a forward side thereof which assist in holding the sighting device 18 with the fingers of user 10. The sighting device 18 further includes a trigger 30 that is used to mark objects that have been sighted. The trigger 30 produces an electronic signal that is used by the tour guide system 16, as will be further explained below.

In order to determine the relationship of the object being viewed relative to the location of the user 10, the sighting device 18 further includes a tilt indicator 32, such as an inclinometer, disposed therein. The tilt indicator 32 determines the tilt of the barrel portion 24 as the user 10 is sighting a point of interest. The tilt indicator 32 is capable of generating a tilt data signal responsive to the tilt of the barrel portion 24. Additionally, a bearing indicator 34 such as a compass is disposed within the sighting device 18. The bearing indicator 34 determines the compass direction the barrel portion 24 is pointed and thereby generates a corresponding bearing data signal. The sighting device 18 may further include a jack 38 disposed within the barrel portion 24. The jack 38 is used for connecting a set of headphones 40 to the tour guide system 16 in order to allow the user 10 to receive audio information from a storage device 46, as will be further explained below. The sighting device 18 further includes a cable 36 in electrical communication with the jack 38, trigger 30, bearing indicator 34, and tilt indicator 32 for transferring the respective data signals therefrom.

Referring to FIG. 2, the bearing and tilt data signals from cable 36 are directed to a processing module 42 of tour guide system 16. Additionally, a location data signal responsive to the present location of the aircraft 12 is in electrical communication with the processing module 42. The location data signal can be generated from the location finding system (i.e., Navigation and/or GPS system) of the aircraft 12 or another source. If the personal tour guide system 16 is used in an aircraft 12, an altitude data signal responsive to the altitude of the aircraft 12 is in electrical communication with the processing module 42. The altitude data signal may be generated by the location finding system (i.e., navigation and/or GPS system) of the aircraft 12 or from another source. The tilt, bearing, altitude and location data signals, which are current at the time the trigger 30 is operated, can then be used to determine the location of the object or point of interest the user 10 is viewing with sighting device 18, as will be further explained below. As will be recognized to those of ordinary skill in the art, the location finding system may be a local positioning system that provides greater resolution of the location for the personal tour guide system 16. For example, if the personal tour guide system 16 is being used within a museum, the local positioning system is placed within the museum and provides increased resolution as to the location of the user 10 and personal tour guide system 16.

The processing module 42 includes the storage device 46 and a central processing unit (CPU) 44 which is configured to process the incoming data signals and determine the location of the object or point of interest being viewed by the user 10. Once the location of the object being viewed is determined, the CPU 44 can retrieve information about such an object from the storage device 46. The storage device 46 may be a CD ROM, DVD, magnetic tape, or any other type of medium capable of storing either audio and/or video information regarding points of interest. In the preferred embodiment of the present invention, the storage device 46 contains information (i.e., data) about points of interest within the region of the flight path of aircraft 12. The information is indexed via geographic location such that by knowing the geographic location of an object, the information is easily retrievable. Therefore, once the CPU 44 determines the location of the object being viewed through sighting device 18 by the user 10, the CPU 44 can retrieve the information about such object from the storage device 46. Alternatively, the information on storage device 46 may be indexed via a lookup table. In this instance, the CPU 44 would determine coordinates for the object being viewed that would be used in the lookup table. The lookup table would direct the CPU 44 to the location of the information on the storage device 46. The processing module 42 is configured to output the information about the object through an audio output 48 and/or a video output 50 depending on the type of information stored in the storage device 46.

In the preferred embodiment of the present invention, the information about the object being viewed can be presented in audio and/or video format. If the information is in audio format, the user 10 may listen to such information through headphones 40 plugged into the jack 38 of the sighting device 18. In this respect, the audio output 48 is in electrical communication with the jack 38 through cable 36. If video information about a selected object is available, it may be sent through video output 50 to a display 51 mounted in a seat back 53 in front of the user 10 as seen in FIG. 1. As will be recognized to those of ordinary skill in the art, the audio and video outputs 48 and 50 may be connected to the aircraft's in-flight entertainment system. In this respect, any information from the storage device 46 can be presented to the user 10 through the existing in-flight system of aircraft 12.

In order to operate the personal tour guide system 16, the user 10 will sight an object or point of interest through the sights 20 and 22 of sighting device 18. When the object or point of interest is viewed through the sights 20 and 22, the user 10 depresses the trigger 30 on sighting device 18. The depressed trigger 30 informs the processing module 42 that the user 10 is viewing a selected point of interest and wishes to receive information about such. When the trigger 30 is depressed, the CPU 44 immediately stores the present tilt and bearing information in order to determine the relationship between the position of the point of interest being observed and the user 10. The CPU 44 also immediately stores the altitude, longitude, and latitude of the user 10 which are given from the GPS and altimeter signals from the aircraft's navigation system and/or a separate source.

The tour guide system 16 then uses simple trigonometric principles to determine the location of the selected point of interest. As seen in FIG. 5, the altitude “A” of the aircraft 12 as well as the present location thereof is known from the navigation systems of aircraft 12 or a separate source. The sighting device 18 determines bearing data as represented as a compass bearing 52 relative to magnetic North for the object being viewed. The tilt data determined from the sighting device 18 is the angle “φ”, as seen in FIG. 5. By determining angle “φ” and altitude “A”, it is possible to determine the location of the point of interest on the ground relative to the location of the aircraft 12. For example, as seen in FIG. 5, a lake 55 is being viewed through the sighting device 18. Angle “φ” is determined by the tilt indicator 32 and compass bearing 52 is determined by the bearing indicator 34 disposed within the sighting device 18. The altitude “A” of the aircraft 12 is additionally known. With this information, it is possible to calculate the distance and bearing to the lake 55 relative to the location of the earth directly below the aircraft 12. As the location of the earth directly below the aircraft 12 is known from the GPS system, it is possible for the CPU 44 to determine the position of the lake 55. With the position of the lake 55 determined, it is then possible to retrieve appropriate information, relating to the lake, which is at that given location, from the storage device 46.

As will be recognized to those of ordinary skill in the art, if the object being viewed with the sighting device 18 is located along the horizon, the resolution of the tilt indicator 32 may be greatly diminished. In this respect, it may be difficult for the CPU 44 to determine the exact object being viewed. Therefore, it is contemplated that an out of range indication be displayed when the tilt indicator 32 determines that the object being viewed is near the horizon. In such situation, the CPU 44 will alert the user 10 and allow the user 10 the option of either manually overriding the system to present information about the closest object near the aircraft 12, or automatically scroll through information about objects along the line of sight of the sighting device 18. If the user 10 decides to allow the system 16 to automatically scroll through objects in the line of sight of the sighting device 18, the user 10 may be given the option to receive information about one or more of the objects.

It is additionally contemplated that the personal tour guide system 16 may be positioned on a fixed landmark such as an observation deck 56 of a building or tourist attraction. Since the sighting device 18 is to be operated exclusively from the observation deck 56, the altitude and location of the sighting device 18 is known. The sighting device 18 will transmit bearing and tilt data signals to the CPU 44 which will then determine from the tilt and bearing information, relative to the observation deck 56, and a prior mapping exercise which catalogued all such observations, the object or building 54 that the user 10 is viewing. The CPU 44 can then retrieve information about the object or building 54 from storage device 46 and can present it in either audio and/or video format to the user 10.

It will be recognized by those of ordinary skill in the art that even though the present invention has been described as sighting points of interest, the personal tour guide system 16 can be used for astronomical purposes. Specifically, sighting device 18, which may be an accessory to a telescope, can be pointed toward an astronomical object such as a star or planet. The tilt and bearing information from the sighting device 18, in addition to the known location of the observation point, will provide the CPU 44 the ability to reference a previously established data base which recorded appropriate observations, such as the name and type of astronomical objects, at each angle of rotation and tilt relative to that observation point. The previously established data base shall be stored on the storage device 46. Such information shall then be presented to the user 10, as previously described.

The present invention may further be utilized to record information about a sighted object. Once the point of interest has been identified by the personal tour guide system 16, the user 10 may wish to record information about such object. The CPU 44 can record information about such object either on the storage device 46 or other type or recordable medium. The recorded information will be indexed by the location of the object being viewed for easy retrievability later on. The user 10 can enter the information through either a keyboard, pointing device (i.e., mouse) or microphone.

Furthermore, it is contemplated that the personal tour guide system 16 can be equipped to provide directions toward a point of interest which was selected from a range of options on a menu. In this respect, the personal tour guide system 16 will include an input device such as a keyboard or pointing device. The user 10 will enter by use of the input device, a selected point of interest from the menu which he or she wishes to locate by use of the personal tour guide system 16. The storage device 46 will include information about the object selected as well as its location. The sighting device 18 would be equipped with a direction indicator to inform the user 10 the direction that the sighting device 18 should be pointed. Specifically, the sighting device 18 would include four LED's that would indicate to the user 10 the direction the sighting device 18 should be pointed in order to view the selected object. A first pair of LED's would be placed horizontally across from one another as left and right indicators, and a second pair of LED's would be placed vertically across from one another as up and down indicators. The bearing indicator 34 and the tilt indicator 32 inform the CPU 44 the direction the sighting device 18 is pointing such that the proper LED's may be illuminated to redirect the sighting device 18 toward the object or point of interest. For example, if the processing module 42 determines that the sighting device 18 should be directed to the right, then the right LED would illuminate. Additionally, if the processing module 42 determines that the sighting device 18 should be pointed upwardly, then the top LED would be illuminated. If none of the LED's are illuminated, then the sighting device 18 is pointing in the direction of the selected point of interest. The user 10 will then look through the forward and rear sights 20, 22 to view the selected object.

As will be recognized to those of ordinary skill in the art, it may be advantageous for the personal tour guide system 16 to have the ability to pinpoint the location of an object through the use of a range finder. The range finder can be an infrared, laser or radar range finder that determines the distance between the object to be viewed and the sighting device 18. This feature is especially useful in walking city tours whereby the range finder can discriminate between the buildings being viewed by the system 16. The range finder determines distance information that is used by the CPU 44 to determine the exact building being viewed by the user 10.

Additional modifications and improvements of the present invention may also be apparent to those of ordinary skill in the art. Thus, the particular combination of parts described and illustrated herein is intended to represent only a certain embodiment of the present invention, and is not intended to serve as limitations of alternative devices within the spirit and scope of the invention.

What is claimed is:

1. A personal tour guide system for providing information about a selected point of interest within a prescribed region, the system comprising:
a sighting device for determining a selected point of interest within the prescribed region;
a storage device including data corresponding to the prescribed region, the storage device being in communication with the sighting device such that the data regarding the selected point of interest within the prescribed region is accessible by directing the sighting device toward the selected point of interest; and
an output device in communication with the storage device and operative to output the data regarding the selected point of interest.

2. The system of claim 1 wherein the sighting device comprises a bearing indicator and a tilt indicator operative to determine the selected point of interest.

3. The system of claim 2 wherein the bearing indicator is a compass and the tilt indicator is an inclinometer.

4. The system of claim 1 further comprising a processor in communication with the sighting device and the storage device, the processor being configured to determine the location of the selected point of interest and access the data corresponding to the selected point of interest.

5. The system of claim 4 wherein the system is implemented on an environment having available altitude and location information, and the processor is configured to determine the location of the selected point of interest from the altitude and location information.

6. The system of claim 4 wherein the sighting device further comprises at least one LED and the processor is configured to determine the direction toward the selected point of interest and illuminate the corresponding LED of the sighting device.

7. The system of claim 6 wherein the at least one LED comprises four LEDs.

8. The system of claim 7 wherein two LEDs indicate an up and down direction and two LEDs indicate a left and right direction.

9. The system of claim 1 wherein the data about the selected region is in an audio format.

10. The system of claim 9 wherein the output is a speaker.

11. The system of claim 1 wherein the data about the selected region is in a video format and the output is a video screen.

12. A method of providing information about a selected point of interest within a prescribed region with a personal tour guide system having a sighting device, a storage device containing data about the prescribed region and an output device, the method comprising the steps of:
a) viewing the selected point of interest with the sighting device;
b) determining a location of the selected point of interest with the sighting device;
c) retrieving data about the selected point of interest with the storage device; and
d) presenting the data about the selected point of interest with the output device.

13. The method of claim 12 wherein the sighting device includes a bearing indicator and a tilt indicator and step (b) further includes determining the location of the selected point of interest using the bearing indicator and the tilt indicator.

14. The method of claim 12 wherein the storage device comprises data in an audio format and step (d) comprises presenting the data about the selected point of interest in audio.

15. The method of claim 14 wherein the output device is a speaker and step (d) comprises presenting the data with the speaker.

16. The method of claim 12 wherein the storage device comprises data about the selected point of interest in a video format and step (d) comprises presenting the data about the selected point of interest in video.

17. The method of claim 16 wherein the output device is a video display and step (d) comprises presenting the data on the video display.
